(19) United States
(12) Patent Application Publication
(10) Pub. No.: US 2008/0130936 A1
(43) Pub. Date: Jun. 5, 2008

(54) ONLINE AUDIO AVAILABILITY DETECTION

(75) Inventors: Wilmer Lau, Danville, CA (US); Timothy P. Johnston, Los Gatos, CA (US); Robert M. Khamashta, Campbell, CA (US); Edward L. Reuss, Santa Cruz, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: PLANTRONICS, INC., Santa Cruz, CA (US)

(21) Appl. No.: 12/031,587

(22) Filed: Feb. 14, 2008

Related U.S. Application Data
(63) Continuation-in-part of application No. 11/542,385, filed on Oct. 2, 2006.

(51) Int. Cl. H04R 25/00; H04M 1/02

(52) U.S. Cl. 381/370; 379/430

(57) ABSTRACT

In one embodiment, a method for automatically communicating audio availability is provided, the method including providing a headset donned or doffed state, providing the headset donned or doffed state to an instant messaging application, and communicating an audio availability status from the instant messaging application to a remote user interface. An applicable headset for performing the notification method described above is also disclosed.

### CROSS-REFERENCE TO RELATED APPLICATIONS

This application is a continuation-in-part of U.S. application Ser. No. 11/542,385, filed Oct. 2, 2006, entitled “Donned and Doffed Headset State Detection,” the contents of which are incorporated by reference herein for all purposes.

### TECHNICAL FIELD

The present invention relates generally to headset devices and, more particularly, to a method for determination and notification of when an online user is audibly available and a headset therefor.

### BACKGROUND

Instant messaging (IM) is becoming a popular method for communication, and modern instant messaging can handle not only textual communications but also audio and video. Instant messaging is typically on desktop computers but is also becoming popular on mobile devices such as mobile telephones and PDAs. Typical instant messaging applications provide user status information indicating the user's varying willingness to communicate in a conversation.

Logging in and out of an IM system or inputting an audio availability status may be inconvenient and/or inefficient in many circumstances. Thus, a reliable means and method for automatically providing an audio availability status is highly desirable.

### SUMMARY

The present invention provides an advantageous apparatus and method for automatically indicating an audio availability status to a remote user interface, in one example an IM user interface.

In one embodiment of the present invention, a headset is provided, the headset comprising an acoustic transducer, and a detector providing an indication of a headset donned or doffed state. The detector is operably coupled to an instant messaging application for communicating an audio availability status to a remote user interface.

In accordance with another embodiment of the present invention, a method of automatically communicating audio availability is provided, the method comprising providing a headset donned or doffed state, providing the headset donned or doffed state to an instant messaging application, and communicating an audio availability status from the instant messaging application to a remote user interface.

Advantageously, the present invention allows for the automatic indication of audio availability without the need for input through a keyboard or other user interaction, thereby providing for more efficient initiation of an audio conversation.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a system for automatically indicating an audio availability to a remote user interface in accordance with an embodiment of the present invention.

FIG. 2 illustrates a block diagram of a headset capable of indicating a donned or doffed state in accordance with an embodiment of the present invention.

FIG. 3 illustrates a flowchart showing a method for automatic notification of audio availability in accordance with an embodiment of the present invention.

Embodiments of the present invention and their advantages are best understood by referring to the detailed description that follows. It should be appreciated that like reference numerals are used to identify like elements illustrated in one or more of the figures. Elements may not necessarily be drawn to scale.

### DETAILED DESCRIPTION

The prevailing method of communicating through instant messaging (IM) is with a keyboard and a monitor. Currently, in order to change from an “idle” status to an “available” status, a user must provide user input at a computer interface, such as through a keyboard or mouse. A headset coupled (wirelessly or via a wireline) with an instant messaging application provides a natural way for parties to communicate through audio.

Typically, if a user desires to initiate an audio conversation, the user starts a text-based conversation, confirms the remote end user's ability to communicate through audio via text, and initiates a separate audio communication stream. The initiating user does not usually know before starting the initial text-based conversation whether the remote end user can communicate through audio.

In order to communicate through audio, the remote end user must be audio enabled (e.g., having both a microphone and a speaker), and be willing to have an audio conversation (the remote end user may not want to have an audio conversation but instead may prefer a text-based conversation).

The present invention provides an advantageous apparatus and method for automatically providing audio availability status without the need for manual user input such as through a keyboard, thereby more efficiently initiating conversation.

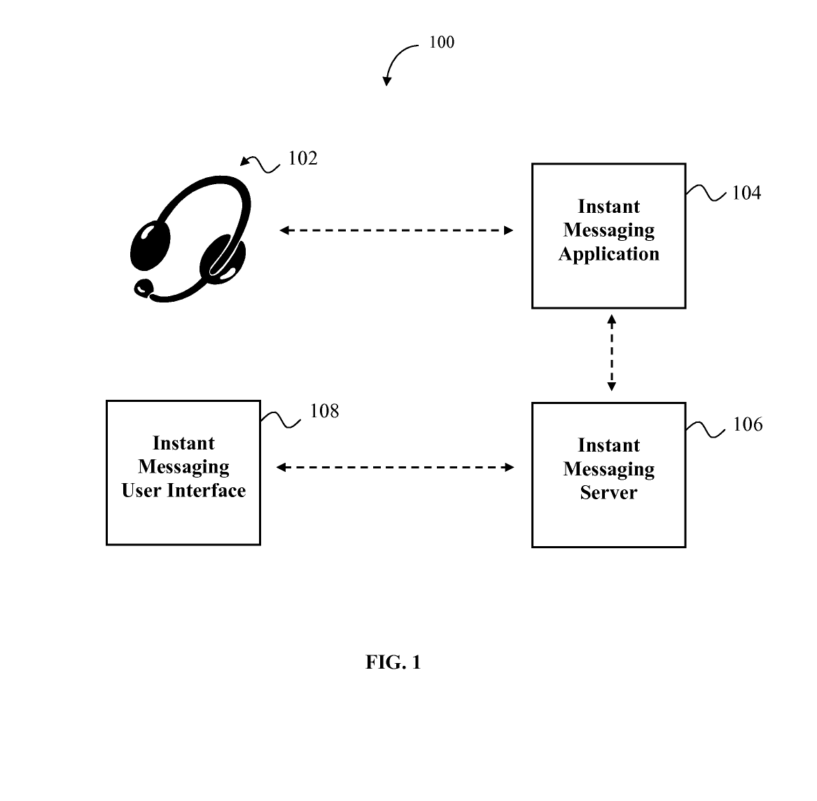

Referring now to FIG. 1, a system 100 for automatically indicating an audio availability status to a remote user interface is illustrated in accordance with an embodiment of the present invention. System 100 includes a headset 102 operably coupled to an instant messaging application 104, which may be operably coupled to an instant messaging server 106. A remote user interface 108, such as an IM user interface, is operably coupled to IM server 106. Other elements may be between headset 102 and remote user interface 108, such as but not limited to, adaptors, access points, and/or networks. It is noted that server 106 may be used to route notifications/status to multiple remote user interfaces.

Headset 102 may be wired or wireless. In one example, headset 102 may be wired to an adaptor which is coupled to a network, or headset 102 may be wirelessly coupled to an access point (AP) (not shown), which is operably coupled with a network. In one example, the network may be a communications network which may include a public switched telephone network (PSTN), an integrated services digital network (ISDN), a local area network (LAN), and/or a wireless local area network (WLAN), that support standards such as Ethernet, wireless fidelity (WiFi), and/or voice over internet protocol (VoIP). In yet another example, headset 102 may support Bluetooth™ protocols for wireless communication with a network.

In one example, an AP includes a transceiver and a processor configured to allow a wireless device (e.g., a headset) access to a network connected to the access point (e.g., via a 10/100 Ethernet RJ-45 port). An AP may be any device that allows wireless-equipped computers and other devices to communicate with a wired network. In one example, an AP is able to support WiFi in general, and the 802.11a, 802.11b, and/or 802.11g wireless networking standards in particular. In other examples, the AP may be able to support other wireless standards such as Bluetooth™.

IM application 104 may include firmware, hardware, and/or software operably coupled to headset 102 for receiving the headset donned/doffed state determination from headset 102 and changing/maintaining an audio availability and/or capability status of the headset user. In one example, IM application 104 may include software available from AOL or Microsoft for instant messaging and/or live communication. Instant messaging application 104 may be within various environments, including but not limited to headset 102, and environments external to the headset, such as a desktop computer, and mobile devices such as a laptop, a mobile telephone, and a PDA.

IM server 106 may include firmware, hardware, and/or software for communication of instant messages over a network, such as the Internet or a LAN, and notification of an audio availability status of the headset user to a remote user interface. IM server 106 is operably coupled to IM application 104 via a network and other means.

IM user interface 108 is operably coupled to IM server 106 via a network and other means, and may include various interfaces that allow for notification to a remote user of an audio availability status of the headset user. In one example, IM user interface 108 may include but is not limited to a desktop computer and monitor, speakers, a mobile telephone, a PDA, and a vibration device.

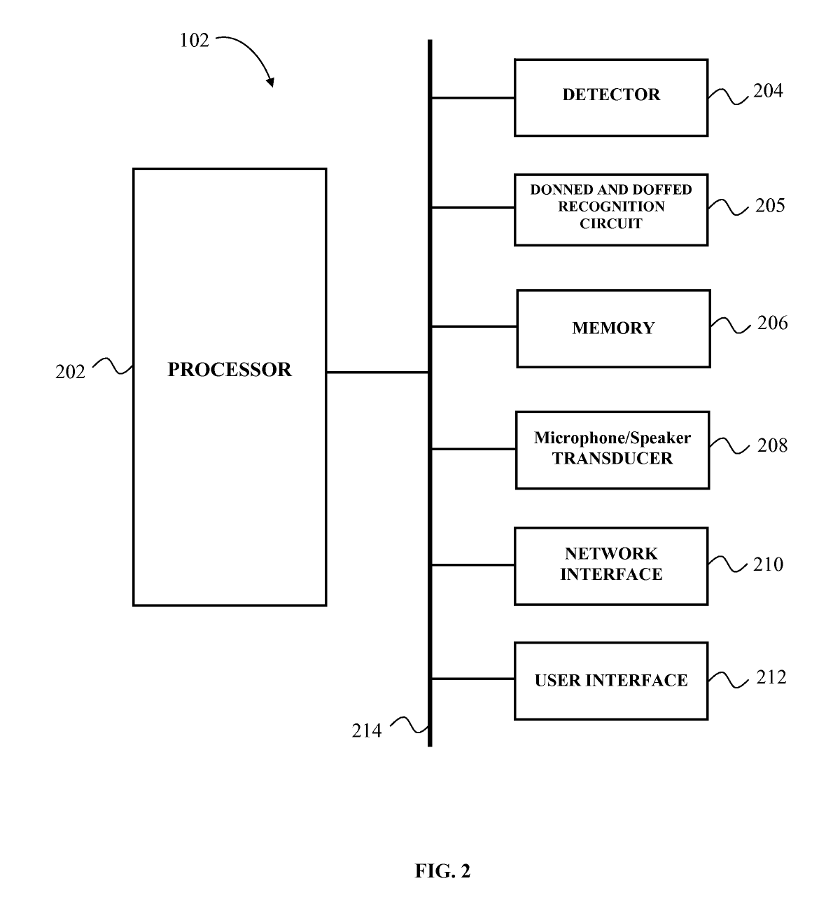

Referring now to FIG. 2 in conjunction with FIG. 1, a block diagram of an example of headset 102 is shown in accordance with an embodiment of the present invention. Headset 102 includes a processor 202 operably coupled via a bus 214 to a detector 204, a donned and doffed determination circuit 205, a memory 206, a transducer 208, a network interface 210, and an optional user interface 212.

Processor 202 allows for processing data, in particular managing data between detector 204, determination circuit 205, and memory 206 for determining the donned or doffed state of headset 102. Processor 202 further provides for sending an indication of the determined donned or doffed headset state to IM application 104 (which may be within memory 206 of headset 102 in one embodiment or external to headset 102 in other embodiments). In one example, processor 202 may also process information about access points, service providers, and service accounts for wireless headsets. In one example, processor 202 is a high performance, highly integrated, and highly flexible system-on-chip (SOC), including signal processing functionality such as echo cancellation/reduction and gain control in another example. Processor 202 may include a variety of processors (e.g., digital signal processors), with conventional CPUs being applicable. In alternative embodiments, processor 202 is not positioned within headset 102 but may be provided in an environment external and operably coupled to the headset, in particular detector 204 and determination circuit 205. In one example, the external environment for processor 202 may be a computer or similar environment as for IM application 104.

Detector 204 provides a mechanism for automatic detection of a headset donned/doffed status, and may be implemented through various means, including proximity sensors, thermal sensors, and mechanical switches. In one example, detector 204 includes a motion detector and/or a non-motion detector providing output charges based upon a headset characteristic such as kinetic energy, temperature, and/or capacitance. Different embodiments of detector 204 are described in U.S. application Ser. No. 11/542,385, which has been previously incorporated by reference herein.

In the case of a motion detector, as the user wears the headset, subtle movements of the head (e.g., from standing, sitting, walking, or running) cause movements of the headset, and detector 204 transfers kinetic energy from head and body movement into an electromotive force, or an output charge. In other words, motion of the headset induces a small fluctuating current flow in a nearby electrical conductor. Current in this conductor is amplified electronically. The output charges may be provided at predetermined or varying intervals (e.g., sampling every 5 seconds) and for predetermined or varying periods (e.g., based on time or number of samples) to form an output charge pattern.

Detector 204 is operably coupled to a determination circuit 205 for determining whether a plurality of the output charges form an output charge pattern corresponding to a state selected from the group consisting of the headset being donned and doffed. In one example, determination circuit 205 compares the output charge pattern to a predetermined profile, and if the pattern is within the bounds of the predetermined profile, the headset is considered to be in a state of being donned. When there is no recognized output charge pattern for a predetermined period, then the headset may be considered to be abandoned and in a state of being doffed. In another embodiment, the output charge pattern may be recognized as a doffed output charge pattern. The output charges may be shaped using a comparator circuit which is connected to an input pin on a general purpose microcontroller. Firmware in the microcontroller may implement a filtering algorithm to discriminate between movement of a headset when doffed and the occasional movements caused by relocating a non-worn headset from one location to another. In this example, determination circuit 205 is an individual component operably coupled to other components of headset 102 via bus 214, but determination circuit 205 may be placed in various locations, for example being integrated with processor 202 or detector 204, stored in memory 206, or being provided external to headset 102, for example at server 106.

In the case of a non-motion detector, as the user wears the headset, detector 204 transfers temperature and/or capacitance readings into an electromotive force, or an output charge. Current in this conductor is amplified electronically and processed as described above with respect to motion detectors. Again, the output charges may be provided at predetermined or varying intervals and for predetermined or varying periods to form an output charge pattern.

It is noted that a variety of detectors that provide an output charge pattern corresponding to a donned or doffed state of a headset are within the scope of the present invention. In critical applications, two or more of the embodiments described above may be used in one headset in order to determine a donned or doffed headset state with greater accuracy and reliability. For example, in one case with one motion detector and one non-motion detector being used, a headset state can be indicated when both detectors indicate the same state.

Memory 206 may include a variety of memories, and in one example includes SDRM, ROM, flash memory, or a combination thereof. Memory 206 may further include separate memory structures or a single integrated memory structure. In one example, memory 206 may be used to store passwords, network and telecommunications programs, and/or an operating system (OS). In one embodiment, memory 206 may store determination circuit 205, output charges and patterns thereof from detector 204, and/or predetermined output charge profiles for comparison to determine the donned and doffed state of a headset. In other embodiments, memory 206 may store IM application 104.

Transducer 208 may include an acoustic transducer, such as a microphone, a speaker, or a combination thereof, for transmission of sound (such as from the user's mouth or to the user's ear based upon signals from an audio source). Transducer 208 may also include a plurality of separate transducers for performing different functions. The transducer can be any type of electromagnetic, piezoelectric, or electrostatic type of driving element, or a combination thereof, or another form of driving element, for generating sound waves from the output face of the transducer. In one embodiment, the transducer may receive signals through wireless communication channels, such as by Bluetooth™ protocols and hardware, in one example.

Network interface 210 allows for communication with APs, and in one example includes a transceiver for communicating with a wireless local area network (LAN) radio transceiver (e.g., wireless fidelity (WiFi), Bluetooth, ultra wideband (UWB) radio, etc.) for access to a network (e.g., a wireless LAN or the Internet), or an adaptor for providing wired communications to a network. In one example, network interface 210 is adapted to derive a network address for the headset using the headset's electronic serial number, which is used to identify the headset on the network. In one embodiment, the electronic serial number may be the headset's Media Access Control (MAC) address; however, the electronic serial number may be any number that is mappable to a network address. Network interface 210 is adapted to communicate over the network using the network address that it derives for the headset. In one embodiment, network interface 210 is able to transmit and receive digital and/or analog signals, and in one example communicates over the network using IP, wherein the network interface uses the headset's MAC address or another globally unique address as its IP address. In particular, network interface 210 may be operably coupled to a network via the IEEE 802.11 protocol. However, the network interface 210 may communicate using any of various protocols known in the art for wireless or wired connectivity.

An example of an applicable network interface and the Internet protocol layers (and other protocols) of interest for the present invention are described in pending U.S. patent application Ser. No. 10/091,905 filed Mar. 4, 2002, the full disclosure of which is hereby incorporated by reference for all purposes.

User interface 212 allows for manual communication between the headset user and the headset, and in one example includes an audio and/or visual interface such that a prompt may be provided to the user's ear and/or an LED may be lit.

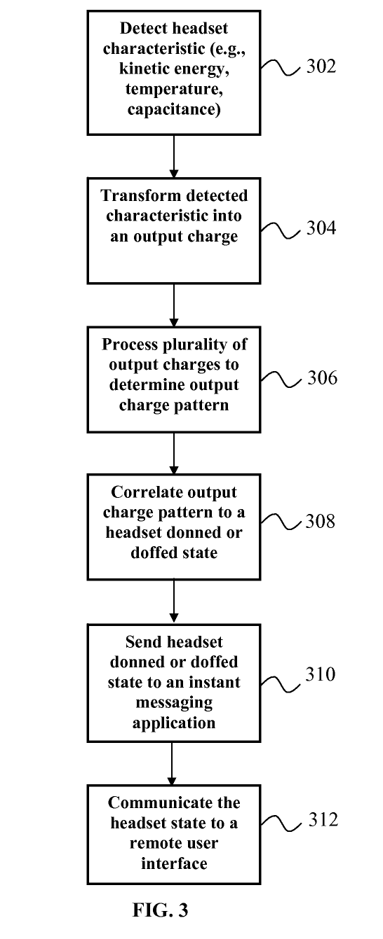

Referring now to FIG. 3 in conjunction with FIGS. 1 and 2, a flowchart of a method for automatic notification of audio availability is illustrated in accordance with an embodiment of the present invention. At step 302, a headset characteristic, such as kinetic energy, temperature, and/or capacitance, is detected by a detector 204. At step 304, the detector provides an output charge corresponding to a detected characteristic. The output charge is amplified and transferred to determination circuit 205. At step 306, a plurality of output charges are processed by determination circuit 205 to determine an output charge pattern. At step 308, determination circuit 205 correlates the output charge pattern to a donned or doffed state of a headset, in one example comparing the output charge pattern to predetermined output charge profiles that reflect a donned or doffed state of a headset. The predetermined output charge profiles may be in look-up tables or a database and may include a variety of parameters, such as for particular headsets and detectors being used.

At step 310, an indication of the headset donned or doffed state may be sent to IM application 104 for changing/maintaining the user status to a respective notification at the remote user interface 108 such as through an audible or visual prompt. In one example, the audio availability status may be provided as an icon corresponding to audio availability or non-availability status, text, a buzzer, or a vibration mechanism at the remote user interface. Donning of a headset may implicitly indicate to IM buddies of the headset user's availability/willingness to receive audio instant messages. At step 312, IM application 104 may then send the audio availability status to IM server 106 for routing/communicating the status to remote user interfaces.

Advantageously, the present invention provides a headset and method for automatic indication of audio availability without the need for manual user input, such as through a keyboard or mouse, thereby providing for more efficient initiation of an audio conversation. A text-based conversation can be automatically bypassed and an audio communication can be immediately initiated with a high likelihood of audio availability and capability.

Embodiments described above illustrate but do not limit the invention. It should also be understood that numerous modifications and variations are possible in accordance with the principles of the present invention. Although headsets are described above, the present invention may be used with a variety of head-worn devices, such as a head-mounted computer display. Accordingly, the scope of the invention is defined only by the following claims.

What is claimed is:

1. A headset, comprising:
an acoustic transducer; and
a detector providing an indication of a headset donned or doffed state, the detector being operably coupled to an instant messaging application for communicating an audio availability status to a remote user interface.

2. The headset of claim 1, wherein the detector is a motion detector that transforms kinetic energy of the headset into an output charge.

3. The headset of claim 1, wherein the detector is a non-motion detector including one selected from the group consisting of an infra-red detector, a pyroelectric sensor, a capacitive sensor, a capacitive circuit, a micro-switch, an inductive proximity switch, and a skin resistance sensor.

4. The headset of claim 1, wherein the detector is operably coupled to a circuit for determining whether an output charge pattern from the detector corresponds to a state selected from the group consisting of the headset being donned and doffed.

5. The headset of claim 1, wherein the detector is operably coupled to the instant messaging application via a wireline or a wireless protocol.

6. The headset of claim 1, wherein the instant messaging application is located within one of the headset, a personal computer external to the headset, a mobile telephone external to the headset, and a PDA external to the headset.

7. The headset of claim 1, wherein the audio availability status is provided as an audio or visual prompt at the remote user interface.

8. The headset of claim 1, wherein the audio availability status is provided as an icon, text, a buzzer, or a vibration mechanism at the remote user interface.

9. The headset of claim 1, further comprising an instant messaging server that provides the audio availability status from the instant messaging application to the remote user interface.

10. Logic encoded in one or more tangible media for execution and when executed operable to:
provide an indication of a headset donned or doffed state;
provide the indication of a headset donned or doffed state to an instant messaging application; and
communicate an audio availability status from the instant messaging application to a remote user interface.

11. The logic of claim 10, wherein the instant messaging application is located within one of the headset, a personal computer external to the headset, a mobile telephone external to the headset, and a PDA external to the headset.

12. The logic of claim 10, wherein the audio availability status is provided as an audible or visual prompt at the remote user interface.

13. The logic of claim 10, wherein the audio availability status is provided as an icon, text, a buzzer, or a vibration mechanism at the remote user interface.

14. The logic of claim 10, further operable to provide the audio availability status from the instant messaging application to the remote user interface via an instant messaging server.

15. A method of automatically communicating audio availability, the method comprising:
providing a headset donned or doffed state;
providing the headset donned or doffed state to an instant messaging application; and
communicating an audio availability status from the instant messaging application to a remote user interface.

16. The method of claim 15, wherein the instant messaging application is located within one of the headset, a personal computer external to the headset, a mobile telephone external to the headset, and a PDA external to the headset.

17. The method of claim 15, wherein the headset donned or doffed state is provided to the instant messaging application via a wireline or a wireless protocol.

18. The method of claim 15, wherein the audio availability status is provided as an audible or visual prompt at the remote user interface.

19. The method of claim 15, wherein the audio availability status is provided as an icon, text, a buzzer, or a vibration mechanism at the remote user interface.

20. The method of claim 15, further comprising communicating the audio availability status from the instant messaging application to an instant messaging server, wherein the instant messaging server communicates the audio availability status to the remote user interface.
